(19) United States
(12) Patent Application Publication
(10) Pub. No.: US 2003/0179216 A1
(43) Pub. Date: Sep. 25, 2003

(54) Multi-resolution video-caching scheme for interactive and immersive videos

(75) Inventor: Leo R. Blume, Palo Alto, CA (US)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: Enroute, Inc.

(21) Appl. No.: 10/104,167

(22) Filed: Mar. 22, 2002

(51) Int. Cl. G09G 5/00

(52) U.S. Cl. 345/625

(57) ABSTRACT

A method and system for transferring interactive videos from a video source to a video display system is disclosed. The method and system reduces the bandwidth required between the video source and the video display system. Rather than transferring all image data from each image frame of an interactive video, only relevant portions of subsequent image frames are transferred. For example, in one embodiment of the present invention, a view window is defined in a current image frame. Then, a view neighborhood is defined for a subsequent image frame. Image data from the subsequent image frame within the view neighborhood is transferred to the video display system.

### CROSS-REFERENCE TO RELATED APPLICATIONS

This application relates to U.S. patent application Ser. No. 09/505,337, entitled “POLYGONAL CURVATURE MAPPING TO INCREASE TEXTURE EFFICIENCY”, filed Feb. 16, 2000 by Hashimoto, et. al., owned by the assignee of this application and incorporated herein by reference.

### FIELD OF THE INVENTION

The present invention relates to digital imaging. More specifically, the present invention relates to methods and systems to provide high quality interactive videos across a limited bandwidth channel having latency.

### BACKGROUND OF THE INVENTION

Interactive videos generally allow a user to control the displayed area of a video. For example, in one form of interactive videos a user is allowed to pan around or zoom into a high resolution video using a display that has lower resolution than the high resolution video. For example, one use of such an interactive video system may be to allow users with standard TV display systems to view videos made for high-definition television systems having high resolution image frames. Another example of interactive videos is an immersive video. Immersive videos make use of environment mapping to create a video that represents the environment surrounding the user. The user controls a view window, which represents what the user can see in a particular direction. Although immersive videos are described in detail herein, the principles of the present invention can be used with other forms of interactive videos.

Environment mapping is the process of recording (capturing) and displaying the environment (i.e., surroundings) of a theoretical viewer. Conventional environment mapping systems include an environment capture system (e.g., a camera system) that generates an environment map containing data necessary to recreate the environment of the theoretical viewer, and an environment display system that processes the environment map to display a selected portion of the recorded environment to a user of the environment mapping system. An environment display system is described in detail by Hashimoto et al., in co-pending U.S. patent application Ser. No. 09/505,337, entitled “POLYGONAL CURVATURE MAPPING TO INCREASE TEXTURE EFFICIENCY”, which is incorporated herein in its entirety. Typically, the environment capture system and the environment display system are located in different places and used at different times. Thus, the environment map must be transported to the environment display system typically using a computer network, or stored on a computer readable medium, such as a CD-ROM or DVD.

FIG. 1(A) is a simplified graphical representation of a spherical environment map surrounding a theoretical viewer in a conventional environment mapping system. The theoretical viewer (not shown) is located at an origin 105 of a three-dimensional space having x, y, and z coordinates. The environment map is depicted as a sphere 110 that is centered at origin 105. In particular, the environment map is formed (modeled) on the inner surface of sphere 110 such that the theoretical viewer is able to view any portion of the environment map. For practical purposes, only a portion of the environment map, indicated as view window 130A and view window 130B, is typically displayed on a display unit (e.g., a computer monitor) for a user of the environment mapping system. Specifically, the user directs the environment display system to display window 130A, display window 130B, or any other portion of the environment map. Ideally, the user of the environment mapping system can view the environment map at any angle or elevation by specifying an associated display window.

FIG. 1(b) is a simplified graphical representation of a cylindrical environment map surrounding a theoretical viewer in a second conventional environment mapping system. A cylindrical environment map is used when the environment to be mapped is limited in one or more axial directions. For example, if the theoretical viewer is standing in a building, the environment map may omit certain details of the floor and ceiling. In this instance, the theoretical viewer (not shown) is located at center 145 of an environment map that is depicted as a cylinder 150 in FIG. 1(b). In particular, the environment map is formed (modeled) on the inner surface of cylinder 150 such that the theoretical viewer is able to view a selected region of the environment map. Again, for practical purposes, only a portion of the environment map, indicated as view window 160, is typically displayed on a display unit for a user of the environment mapping system.

A common way to form environment maps for cylindrical environments is to unroll the surface of the cylinder into a rectangular environment map. Rectangular environment maps are generally used because most graphic and memory system are designed to handle rectangular images. FIGS. 2(a) and 2(b) illustrates an environment map 200 for a cylindrical environment 210. Environment map 200 is formed by “unwrapping” cylindrical environment 210 along a cut 260. Cut 260 forms edges 262 and 264 in cylinder 210. As illustrated in FIG. 2(b), Environment map 200 is rectangular having edges 262 and 264. An environment map for a spherical environment is described in by Hashimoto et al. in U.S. patent application Ser. No. 09/505,337, entitled “POLYGONAL CURVATURE MAPPING TO INCREASE TEXTURE EFFICIENCY”.

Environment mapping is used to generate and display immersive videos. Immersive videos are formed by creating multiple environment maps, ideally at a rate of at least 30 image frames a second, and subsequently displaying selected sections of the multiple environment maps to a user, also ideally at a rate of at least 30 image frames a second. Immersive videos are used to provide a dynamic environment, rather than a single static environment as provided by a single environment map. Alternatively, immersive video techniques allow the location of the theoretical viewer to be moved relative to objects located in the environment. For example, an immersive video can be made to capture a flight in the Grand Canyon. The user of an immersive video display system would be able to take the flight and look out at the Grand Canyon at any angle.

FIG. 3 is a simplified block diagram of a conventional interactive video display system 300 for displaying interactive videos, such as immersive videos, to a user. Interactive video display system 300 includes an Interactive video source 310, a channel 320, a video decoding unit 330, a display 370, a user input device 350, and a view window determination unit 360. Interactive video source 310 sends an Interactive video stream 315, which could be for example an immersive video stream, over channel 320 to video decoding unit 330. Video decoding unit 330 displays a portion of interactive video stream 315 onto a display 370. As explained above, the displayed portion is referred to as the view window. A user (not shown) uses a user input device 350, such as a joystick, a pointing device, or keyboard, to control the movement of the view window. Specifically, user input device 350 is coupled to view window determination unit 360 which calculates view window parameters 365 based on the user's input and the current location of the view window. View window determination unit 360 provides view window parameters 365 to video decoding unit 330.

In interactive video display system 300, every image frame of interactive video stream 315 is transferred to video decoding unit 330. Video decoding unit 330 then decodes the portions of the high resolution image frame needed to display the view window. Because the view window makes up only a small portion of the image frame, much of the data sent from interactive video source 310 over channel 320 is not used. In many situations, channel 320 is the limiting factor to the quality of the immersive video stream. For example, if channel 320 is formed on a wide area computer network, such as the internet, the bandwidth of channel 320 is likely less than 1 megabit per second. However, for high-resolution immersive videos, each environment map before compression may contain over 37,748,736 bits of data. Even with compression each environment map would likely average around 533,333 bits of data. At 30 image frames per second the required bandwidth would be about 16 million bits per second. Because channel 320 typically cannot handle the data required for high-resolution video streams, conventional interactive video display systems with typical channel bandwidths are limited to low resolution video streams. Hence, there is a need for a method to display high-resolution interactive video streams using channels of limited bandwidth.

### SUMMARY OF THE INVENTION

Accordingly, an interactive video display system, for example an immersive video display system, in accordance with an embodiment of the present invention only relevant parts of the video stream is transferred from the video source to the video display system. For example in some embodiments of the present invention, a view window is defined in a current image frame. Then, a first view neighborhood is defined for a subsequent image frame. Image data in the subsequent image frame within the first view neighborhood is transferred to the video display system. In one embodiment of the present invention the view window is defined by adding a view window max move distance around the view window to derive the first view neighborhood. In another embodiment of the present invention, the number of frames between the current image frame and the subsequent image frame is determined. Then a view window max move distance is added around the view window for each frame between the current image frame and the subsequent image frame including the subsequent image frame.

In some embodiments of the present invention, the image frames of the video stream are divided into multiple regions. A set of transfer regions is defined to include regions containing image data that is within the view neighborhood. The set of transfer regions is transferred between the video source and the video display system. Each region of an image frame can be separately encoded or compressed.

The present invention will be more fully understood in view of the following description and drawings.

### BRIEF DESCRIPTION OF THE DRAWINGS

FIG. 1(a) is a three-dimensional representation of a spherical environment map surrounding a theoretical viewer.

FIG. 1(b) is a three-dimensional representation of a cylindrical environment map surrounding a theoretical viewer.

FIGS. 2(a) and 2(b) illustrates an environment map for a cylindrical environment.

FIG. 3 is a simplified block diagram of a conventional interactive video display system.

FIG. 4 illustrates a view window and a view neighborhood in an image frame.

FIG. 5 illustrates latency in an interactive video display system.

FIG. 6 illustrates view neighborhood calculations.

FIG. 7 is a block diagram of an interactive video display system in accordance with one embodiment of the present invention.

FIG. 8 shows an image frame divided into multiple regions in accordance with one embodiment of the present invention.

FIG. 9 shows an image frame divided into multiple regions and having multiple view neighborhoods in accordance with one embodiment of the present invention.

FIG. 10 shows a view window with associated high priority view window and low priority view window in accordance with one embodiment of the present invention.

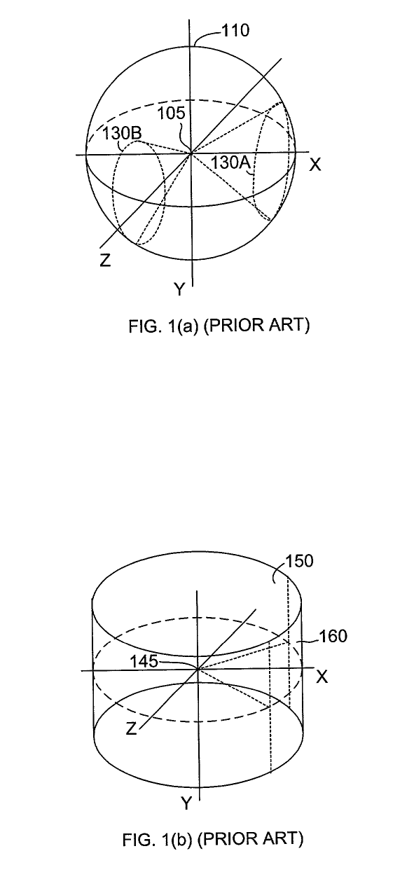

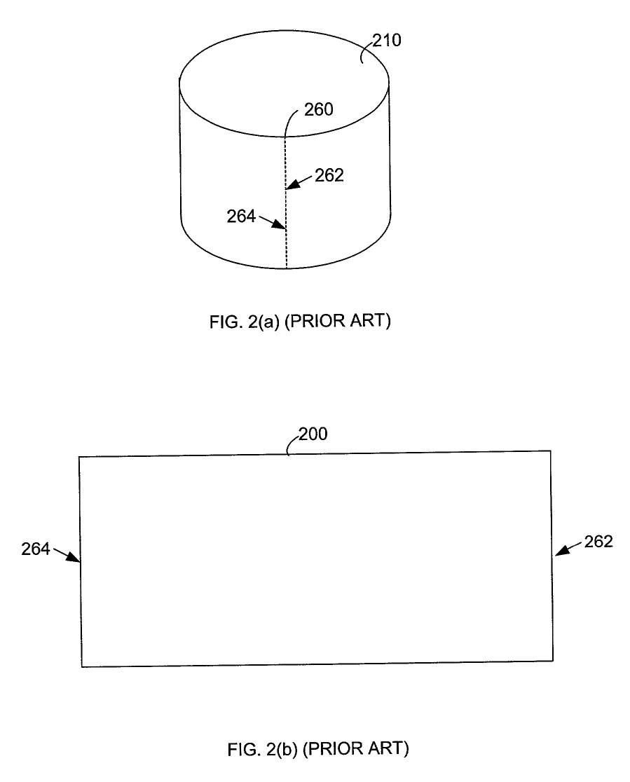

### DETAILED DESCRIPTION

The present invention is directed to an interactive video display system in which the video stream is divided into multiple regions so that only relevant regions of the video stream are transferred from the interactive video source to the video decoding unit. As described above, a user (not shown) uses a user input device to move the view window. Generally, the view window is moved smoothly around the interactive video frames. Therefore, during the transition from a first image frame (i.e. a first environment map) to a second image frame (i.e. a second environment map) of an interactive video, the view window can only move a fixed maximum distance from the original location, hereinafter referred to as the view window max move distance VW_max.

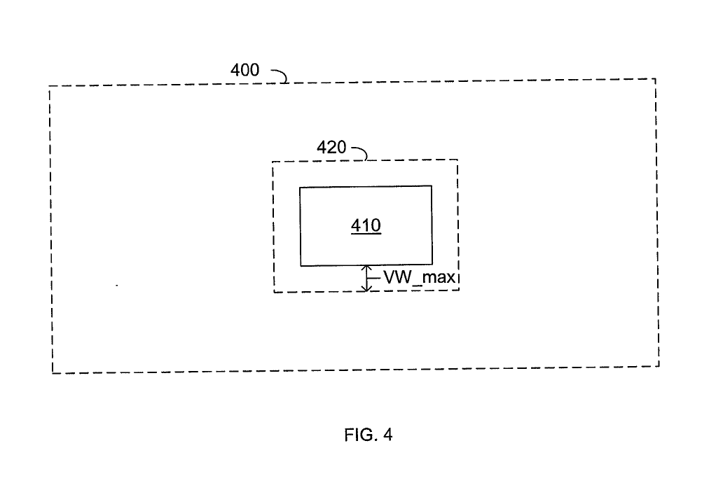

As illustrated in FIG. 4, a view window 410 in image frame (environment map) 400 can only move within a view neighborhood 420 in the next image frame. Thus, to display the next image frame, the interactive video display system only needs to receive the data forming view neighborhood 420 of the next image frame. The size of view neighborhood 420 is dependent on the size of the view window and the view window max move distance VW_max. For example, if the view window can move 5 pixels between each image frame, view neighborhood 420 would be equal to view window 410 plus 5 pixels on each side of view window 410. In some embodiments of the present invention, separate view window max move distances are defined for horizontal and vertical movement of the view window. In other embodiments, the view window max move distances are not rectangular in shape and may not be centered on the view window. If video decoding unit 330 provides feedback to interactive video source 310 regarding view neighborhood 420 in a timely manner, only the data for view neighborhood 420 would need to be transferred over channel 320 rather than an entire image frame. Thus, high resolution immersive videos could be displayed over a channel of limited bandwidth.

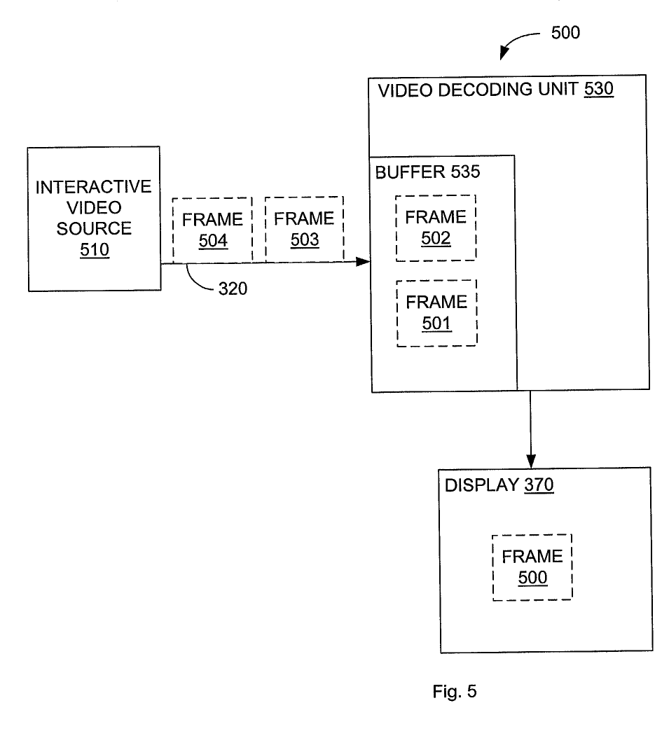

However, channel 320, interactive video source 310, or video decoding unit 330 may have latency greater than the time between image frames. FIG. 5 provides an illustration of the problem latency may cause using a simplified example. In FIG. 5, video decoding unit 530 displays a portion of image frame 500, i.e. the current image frame, in display 370. Image frames 501 and 502 are stored in a buffer 535 of video decoding unit 530. Image frames 503 and 504 are in transit over channel 320. Thus, by the time video decoding unit 530 determines the view window for image frame 500, subsequent image frames 501, 502, 503, and 504 have already left interactive video source 510. Consequently, the next transmission image frame, i.e. the next image frame to be sent by interactive video source 510, is image frame 505. Using view neighborhood 420 based on the display image frame (i.e., image frame 500) on image frame 505 is not sufficient because the view window may have moved significantly in image frames 501, 502, 503 and/or 504. Accordingly, in defining the view neighborhood the latency between the display image frame and the next transmission image frame must be considered.

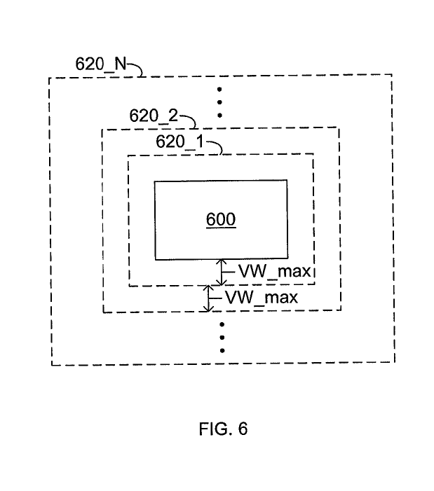

FIG. 6, illustrates one way view neighborhoods can be defined for a view neighborhood 600 to account for latency. Specifically, multiple view windows 620_1, 620_2, . . . 620_N are defined based on the amount of latency in terms of the number of image frames between the display image frame and the next transmission image frame. View neighborhood 620_1 is for the image frame following the display image frame; view neighborhood 620_2 is for the second image frame following the display image frame; and in general view neighborhood 620_N is for the Nth image frame after the display image frame. Thus, for the example of FIG. 5, view neighborhood 620_5 would be used because the next transmission image frame is image frame 505, which is the fifth image frame after the display image frame (i.e. image frame 500). View neighborhood 620_1 is larger than view window 600 by a view window max move distance VW_max on each side. Similarly, view neighborhood 620_2 is larger than view window 600 by 2 times view window max move distance VW_max on each side. In general, view neighborhood 620_N is larger than view window 600 by N times view window max move distance VW_max.

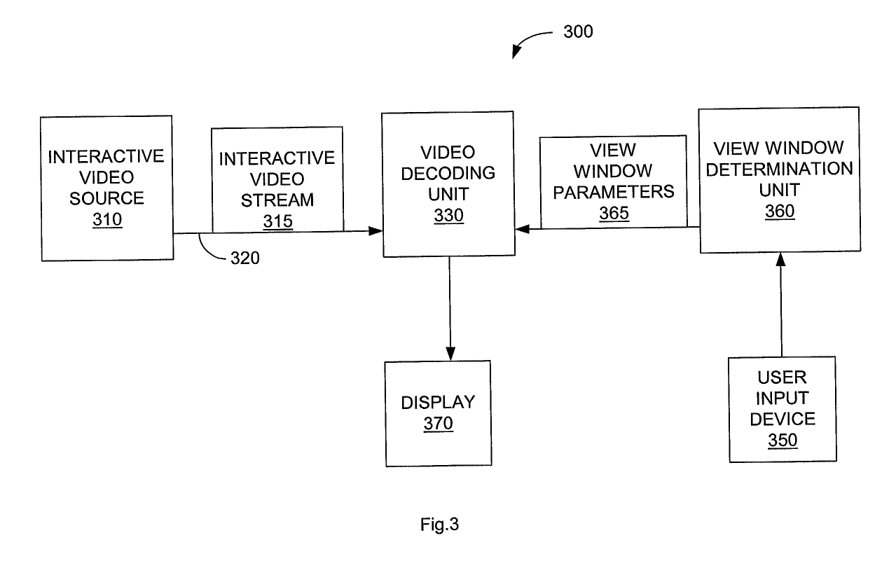

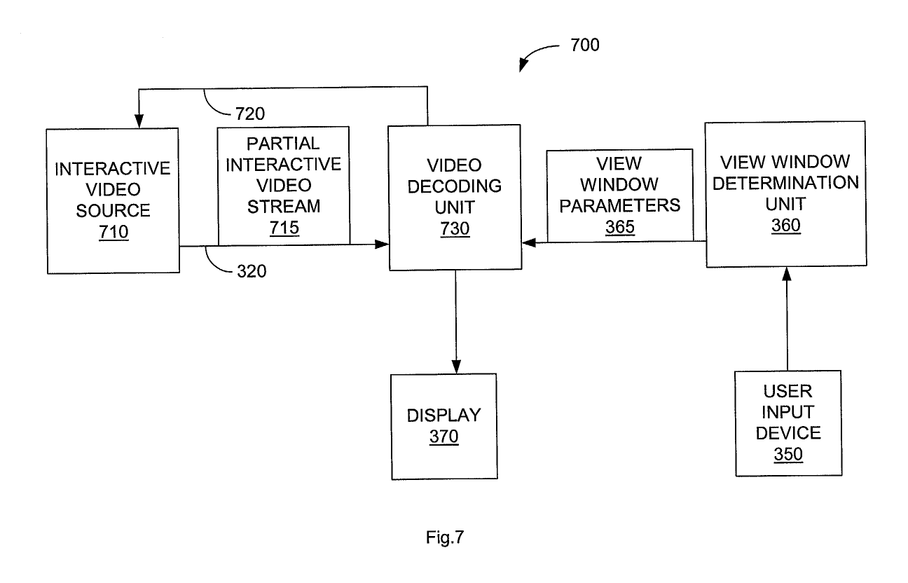

FIG. 7 is a block diagram of an interactive video display system 700 in accordance with one embodiment of the present invention. Because FIG. 7 is similar to FIG. 3, only the differences between FIG. 7 and FIG. 3 are described in detail. Specifically, interactive video display system 700 includes a feedback path 720 between video decoding unit 730 and interactive video source 710. Furthermore, rather than sending a full-frame interactive video stream across channel 320, interactive video source 710 sends a partial interactive video stream 715 to video decoding unit 730. In some embodiments of the present invention, video decoding unit 730 sends interactive video source 710 a view neighborhood to be used with the next transmission image frame. In these embodiments, video decoding unit 730 estimates the latency to be used in the calculation of the view neighborhood. In other embodiments, video decoding unit 730 provides the view window parameters, the display image frame number, and view window max move distance VW_max to interactive video source 710. Interactive video source 710 then generates the view neighborhood for the next transmission image frame as described above.

Generally, the interactive video stream at interactive video source 710 is compressed to reduce the memory requirements of the interactive video stream. Depending on the compression scheme, extraction of the view neighborhood from each image frame may be time consuming. Thus, some embodiments of the present invention divide each image frame of the interactive video stream into a plurality of regions. Each region can be separately encoded or compressed. Any region, which overlaps with the view neighborhood is transmitted to video decoding unit 730.

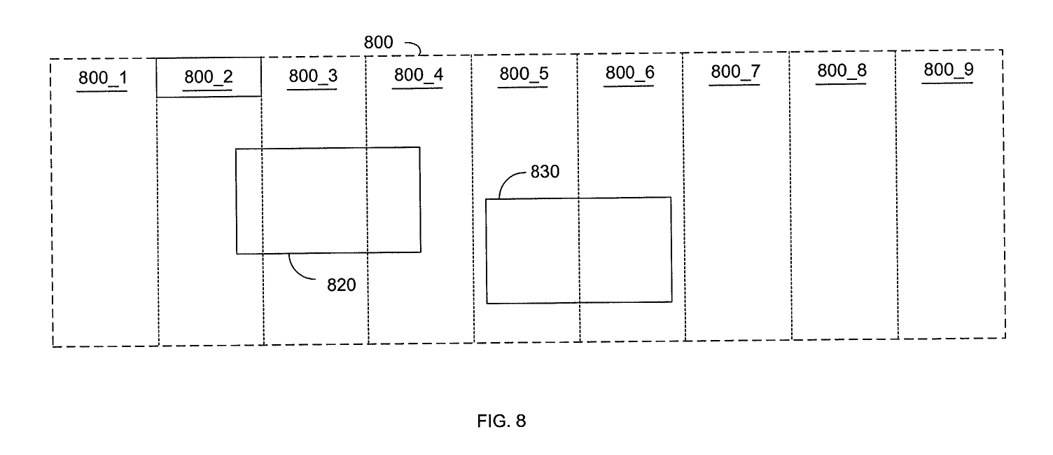

FIG. 8 illustrates how one embodiment of the present invention divides an image frame 800 into regions 800_1, 800_2, 800_3, . . . 800_9, each encompassing 40 degrees of the cylindrical environment. If view neighborhood 820 is used for the next transmission frame, regions 800_2, 800_3, and 800_4 would be transmitted to video decoding unit 730. Similarly, if view neighborhood 830 is used for the next transmission frame, regions 800_5 and 800_6 would be transmitted to video decoding unit 730.

Other embodiments of the present invention may divide the environment maps in different patterns and differing number of regions. For example one embodiment of the present invention divides a cylindrical environment map into 18 regions each encompassing 20 degrees of the cylindrical environment. In another embodiment of the present invention, the environment map is divided into multiple square regions.

In some embodiments of the present invention, individual regions of each environment map can be designated as a high interest region. High interest regions in the next transmission frame are always sent to video decoding unit 730 in addition to any regions selected using the view neighborhood approach described above. High interest regions are generally used for areas of the image frame that are likely to be used often by the viewer. For example, user input device 350 may have a view window homing function that causes the view window to jump to a home area of the image frame. The region or regions containing the home area must be available for video decoding unit 730 to present on display 370. Thus, the high interest regions of each next transmission frame are transmitted to video decoding unit 730.

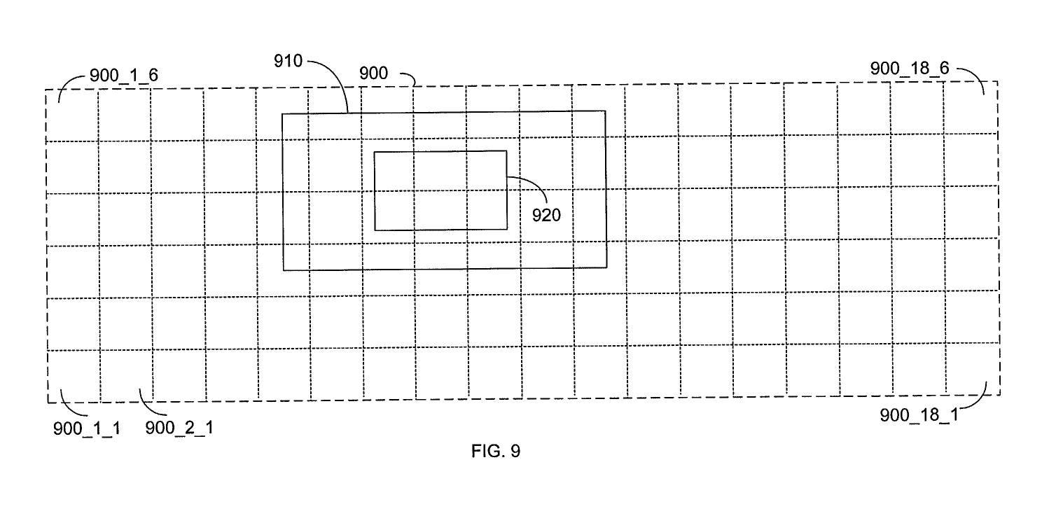

Some embodiments of the present invention may use a dual neighborhood scheme to select regions of the image frame. FIG. 9, illustrates an image frame 900 divided into square regions 900_1_1, 900_2_1, . . . 900_18_1, . . . 900_x_y, 900_1_6, . . . 900_18_6, where region 900_x_y is the region that is x regions to the right of the left edge of the image frame and y regions above the bottom of the image frame. FIG. 9 also includes a low priority view neighborhood 910 and a high priority view neighborhood 920. Generally, high priority view neighborhood 920 is calculated to encompass areas of the next transmission image frame that have a high probability of being viewed by the viewer. Low priority view neighborhood 910 is calculated to encompass areas of the next transmission image frame that may be viewed by the viewer but at a lower probability than the area encompassed by high priority view neighborhood 910. Regions of image frame 900 encompassed by high priority view neighborhood 920 are transmitted to video decoding unit 730 at a high quality. Conversely, regions of image frame 900 encompassed by low priority view neighborhood 910 but not encompassed by high priority view neighborhood 920 are transmitted to video decoding unit 730 at a low quality. Thus, regions 900_7_4, 900_8_4, 900_9_4, 900_7_5, 900_8_5, and 900_9_5 are transmitted at high quality. Regions 900_5_3, 900_6_3, 900_7_3, 900_8_3, 900_9_3, 900_10_3, 900_11_3, 900_5_4, 900_6_4, 900_10_4, 900_11_4, 900_5_5, 900_6_5, 900_10_5, 900_11_5, 900_5_6, 900_6_6, 900_7_6, 900_8_6, 900_9_6, 900_10_6, 900_11_6 are transmitted at low quality. In some embodiments low quality regions are encoded at a lower spatial resolution than high quality regions. In other embodiments, low quality regions are encoded at a lower temporal resolution. In one of these embodiments interactive video source 710 contains a high quality version and a low quality version of every region of every image frame.

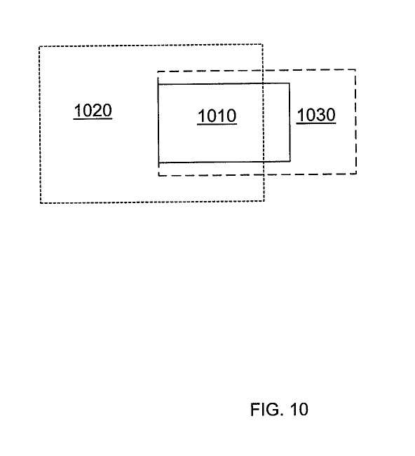

In one embodiment of the present invention, the size and location of the high priority view neighborhood and low-priority view neighborhood are determined by the motion of the view window. Generally, the view window is controlled by a user with a physical pointing input device. The input device itself may provide limitations on the movement of the view window. For example a joystick being pressed to the right by a user, which signals the view window is to move to the right, must transition through a neutral position before being pressed to the left. Thus, the view window has low probability of moving left without first stopping. However, the view window has a high probability of continuing to move to the right. Therefore, regions of high probability would be those along the path of movement. Lower probability regions would be off the current path of movement with the lowest probability regions being those in the opposite direction to the path of movement. FIG. 10 illustrates the selection of a low-priority view neighborhood 1020 and a high-priority view neighborhood 1030 for a view window 1010 moving towards the right of the page. As explained above, view window 1010 is likely to continue to move to the right. Therefore, high priority view neighborhood 1030 encompasses and extends to the right of view window 1010. Conversely, view window 1010 is unlikely to reverse directions suddenly. Thus, low-priority view neighborhood 1020 extends to the left of current view window 1010.

In the above-described manner, high-resolution and high frame rate interactive videos can be transmitted over channels whose bandwidth and latency constraints would otherwise limit the transmission to low quality video. Specifically, an interactive video display system in accordance with embodiments of the present invention reduces bandwidth requirements by defining a view neighborhood for each image frame and transmitting partial image frames based on the view neighborhoods. The various embodiments of the structures and methods of this invention that are described above are illustrative only of the principles of this invention and are not intended to limit the scope of the invention to the particular embodiments described. For example, in view of this disclosure, those skilled in the-art can define other interactive video sources, video decoding units, user input devices, view neighborhoods, image frames, environment maps, environments, and so forth, and use these alternative features to create a method or system according to the principles of this invention. Thus, the invention is limited only by the following claims.

1. A method of transferring an interactive video stream having a plurality of image frames from an interactive video source to a video display system, the method comprising:
defining a view window of a current image frame;
defining a first view neighborhood for a subsequent image frame;
transferring image data in the subsequent image frame within the first view neighborhood to the video display system.

2. The method of claim 1, wherein the defining a first view neighborhood for a subsequent image frame comprises adding a view window max move distance around the view window to derive the first view neighborhood.

3. The method of claim 1 wherein the defining a first view neighborhood for a subsequent image frame comprises:
determining a number of frames between the current image frame and the subsequent image;
adding a view window max move distance around the view window for each frame between the current image frame and the subsequent image frame including the subsequent image frame.

4. The method of claim 1, further comprising dividing the subsequent image frame into a plurality of regions.

5. The method of claim 4, further comprising selecting a set of transfer regions in the second image, wherein each transfer region contains image data within the first view neighborhood.

6. The method of claim 4, wherein the transferring image data in the subsequent image frame within the first view neighborhood to the video display system comprises transferring the transfer regions of the second image to the video display system.

7. The method of claim 4, wherein each region of the subsequent image frame is separately encoded.

8. The method of claim 4, wherein each region of the subsequent image frame is separately compressed.

9. The method of claim 1, further comprising:
defining a high interest region in the subsequent image frame; and
transferring the high interest region of the subsequent image frame to the video display system.

10. The method of claim 1, further comprising defining a second view neighborhood in the subsequent image frame.

11. The method of claim 10, wherein the second view neighborhood encompasses the first view neighborhood.

12. The method of claim 10, wherein the motion of the view window is used in defining the first view neighborhood and the second view neighborhood.

13. The method of claim 10, further comprising transferring image data within the second view neighborhood of the second image but not within the first view neighborhood of the second image to the video display system.

14. The method of claim 10, wherein the image data transferred from within the first view neighborhood is of a high quality and the image data transferred from within the second view neighborhood is of a low quality.

15. A method of displaying an interactive video stream having a plurality of image frames from a video source, the method comprising:
defining a view window of a current image frame;
defining a first view neighborhood for a subsequent image frame;
transferring the first view neighborhood to the video source; and
receiving image data from a subsequent image frame within the first view neighborhood from the video source.

16. The method of claim 15, wherein the defining a first view neighborhood for a subsequent image frame comprises adding a view window max move distance around the view window to derive the first view neighborhood.

17. The method of claim 15 wherein the defining a first view neighborhood for a subsequent image frame comprises:
determining a number of frames between the current image frame and the subsequent image frame;
adding a view window max move distance around the view window for each frame between the current image frame and the subsequent image frame including the subsequent image frame.

18. A method of displaying an interactive video stream having a plurality of image frames from a video source, the method comprising:
defining a view window of a current image frame;
transferring information regarding the view window to the video source; and
receiving image data within from a subsequent image frame within a first view neighborhood from the video source.

19. The method of claim 18, wherein the information includes a plurality of view window coordinates.

20. The method of claim 18, wherein the information includes a frame number of the current image frame.

21. A method of transferring an interactive video stream having a plurality of image frames from an interactive video source to a video display system, the method comprising:
transferring image data from a first image frame;
receiving information regarding a view window of the first image frame;
defining a first view neighborhood for a subsequent image frame based on the information regarding the view window;
transferring image data from the subsequent image frame within the first view neighborhood to the video display system.

22. The method of claim 21, wherein the information includes a frame number of the first image frame.

23. The method of claim 21, wherein the defining a first view neighborhood for a subsequent image frame based on the information regarding the view window comprises adding a view window max move distance around the view window to derive the first view neighborhood.

24. The method of claim 21, wherein the defining a first view neighborhood for a subsequent image frame based on the information regarding the view window comprises:
determining a number of frames between the first image frame and the subsequent image frame;
adding a view window max move distance around the view window for each frame between the first image frame and the subsequent image frame including the subsequent image frame.

25. A system for transferring an interactive video stream having a plurality of image frames from an interactive video source to a video display system, the system comprising:
means for defining a view window of a current image frame;
means for defining a first view neighborhood for a subsequent image frame;
means for transferring image data in the subsequent image frame within the first view neighborhood to the video display system.

26. The system of claim 25, wherein the means for defining a first view neighborhood for a subsequent image frame comprises means for adding a view window max move distance around the view window to derive the first view neighborhood.

27. The system of claim 25 wherein the means for defining a first view neighborhood for a subsequent image frame comprises:
means for determining a number of frames between the current image frame and the subsequent image;
means for adding a view window max move distance around the view window for each frame between the current image frame and the subsequent image frame including the subsequent image frame.

28. The system of claim 25, further comprising means for dividing the subsequent image frame into a plurality of regions.

29. The system of claim 28, further comprising means for selecting a set of transfer regions in the second image, wherein each transfer region contains image data within the first view neighborhood.

30. The system of claim 28, wherein the means for transferring image data in the subsequent image frame within the first view neighborhood to the video display system comprises means for transferring the transfer regions of the second image to the video display system.

31. The system of claim 28, wherein each region of the subsequent image frame is separately encoded.

32. The system of claim 28, wherein each region of the subsequent image frame is separately compressed.

33. The system of claim 25, further comprising:
means for defining a high interest region in the subsequent image frame; and
means for transferring the high interest region of the subsequent image frame to the video display system.

34. The system of claim 25, further comprising means for defining a second view neighborhood in the subsequent image frame.

35. The system of claim 34, wherein the second view neighborhood encompasses the first view neighborhood.

36. The system of claim 34, further comprising means for transferring image data within the second view neighborhood of the second image but not within the first view neighborhood of the second image to the video display system.

37. A system for displaying an interactive video stream having a plurality of image frames from a video source, the system comprising:
means for defining a view window of a current image frame;
means for defining a first view neighborhood for a subsequent image frame;
means for transferring the first view neighborhood to the video source; and
means for receiving image data from a subsequent image frame within the first view neighborhood from the video source.

38. The system of claim 37, wherein the means for defining a first view neighborhood for a subsequent image frame comprises means for adding a view window max move distance around the view window to derive the first view neighborhood.

39. The system of claim 37, wherein the means for defining a first view neighborhood for a subsequent image frame comprises:
means for determining a number of frames between the current image frame and the subsequent image frame;
means for adding a view window max move distance around the view window for each frame between the current image frame and the subsequent image frame including the subsequent image frame.

40. A system for displaying an interactive video stream having a plurality of image frames from a video source, the system comprising:
means for defining a view window of a current image frame;
means for transferring information regarding the view window to the video source; and
means for receiving image data within from a subsequent image frame within a first view neighborhood from the video source.

41. The system of claim 40, wherein the information includes a plurality of view window coordinates.

42. The system of claim 40, wherein the information includes a frame number of the current image frame.

43. A system for transferring an interactive video stream having a plurality of image frames from an interactive video source to a video display system, the system comprising:
means for transferring image data from a first image frame;
means for receiving information regarding a view window of the first image frame;
means for defining a first view neighborhood for a subsequent image frame based on the information regarding the view window;
means for transferring image data from the subsequent image frame within the first view neighborhood to the video display system.

44. The system of claim 43, wherein the means for defining a first view neighborhood for a subsequent image frame based on the information regarding the view window comprises means for adding a view window max move distance around the view window to derive the first view neighborhood.

45. The system of claim 44, wherein the means for defining a first view neighborhood for a subsequent image frame based on the information regarding the view window comprises:
means for determining a number of frames between the first image frame and the subsequent image frame;
means for adding a view window max move distance around the view window for each frame between the first image frame and the subsequent image frame including the subsequent image frame.
